(19) United States
(12) Patent Application Publication
(10) Pub. No.: US 2021/0252438 A1
(43) Pub. Date: Aug. 19, 2021

(54) Filter Element with a Receiving Chamber Containing a Drying Agent, and Fluid Filter

(71) Applicant: MANN+HUMMEL GmbH, Ludwigsburg (DE)

(72) Inventors: Marius Panzer, Ludwigsburg (DE); Alexander Traut, Bad Rodach (DE)

(21) Appl. No.: 17/194,689

(22) Filed: Mar. 8, 2021

Related U.S. Application Data
(63) Continuation of application No. PCT/EP2019/072004, filed on Aug. 16, 2019.

(30) Foreign Application Priority Data
Sep. 11, 2018 (DE) 10 2018 122 079.0

(51) Int. Cl. B01D 35/153; B01D 35/16; B01D 29/21

(52) U.S. Cl. CPC B01D 35/153; B01D 29/21; B01D 35/16

(57) ABSTRACT

A filter element for filtering a liquid has a filter medium that surrounds a longitudinal axis of the filter element in a ring shape and can be flowed through by the liquid in a radial direction in relation to the longitudinal axis. A flow-through receiving chamber is provided that is delimited, at least in sections thereof, by a wall that can be flowed through by the liquid, wherein the receiving chamber contains a drying agent for removal of water from the liquid. The filter medium and the receiving chamber containing the drying agent are non-detachably connected to each other. A fluid filter with a filter housing in which such a filter element is arranged is provided. The filter element is arranged in the filter housing such that, in operation of the fluid filter, both filter medium and receiving chamber containing the drying agent are flowed through by the liquid.

### CROSS-REFERENCE TO RELATED APPLICATIONS

This application is a continuation application of international application No. PCT/EP2019/072004 having an international filing date of 16 Aug. 2019 and designating the United States, the international application claiming a priority date of 11 Sep. 2018 based on prior filed German patent application No. 10 2018 122 079.0, the entire contents of the aforesaid international application and the aforesaid German patent application being incorporated herein by reference.

### TECHNICAL FIELD

The invention concerns a filter element for filtering a fluid, in particular oil, with a receiving chamber which, at least in sections thereof, is delimited by a wall through which the fluid can flow and in which a drying agent for removal of water from the fluid is received. Moreover, the invention concerns a fluid filter with such a filter element.

### BACKGROUND OF THE INVENTION

In fluid-conducting systems, it may happen that water collects in the fluid due to various processes. The water can reach the system, for example, by air exchange with the environment and collect in the fluid. Water can be produced as a reaction product. Likewise, free water can be introduced into the system from the environment. The water can be present in the fluid as free or dissolved water. The water in the fluid can cause undesirable effects such as, for example, corrosion of fluid-conducting components of the system, an increase or decrease of the electrical conductivity of the fluid, and/or reduction of the service life of the fluid, i.e., a shortening of service intervals. At low temperatures, ice crystals may form that block the system.

In particular when the fluid is supplied repeatedly and/or continuously to a component of the system, for example, for cooling and/or lubricating the component, it typically must be ensured that the fluid does not carry with it an excessive amount and/or excessively large particulate contaminants. For removal of such particulate contaminants, filter elements with a filter medium through which the fluid can flow are employed.

DE 36 07 569 A1 discloses a refillable filter dryer arrangement. The arrangement comprises a housing in which an exchangeable core with a central bore is arranged which can be a filter element, dryer element or screen element or a combination thereof. The core is comprised of two separate sections which are arranged so as to be axially positioned on top of each other. A conical combination part with a screen projects into the lower section of the core. The core can be exchanged when it is soiled, clogged or exhausted.

DE 195 45 791 A1 describes a filter dryer for stationary cooling systems. In the interior of a housing of the filter dryer, two filter dryer cartridges are arranged so as to be axially positioned on top of each other. Each filter dryer cartridge comprises a cartridge housing with a cup-shaped bottom part whose bottom is provided with a plurality of perforations. A thin felt layer is placed onto the bottom of the bottom part; subsequently, the interior of the bottom part is filled with a loose fill of the drying agent. A second thin felt layer is applied to the top side of the drying agent fill. Subsequently, a cover with a plurality of perforations is placed thereon. The drying agent can be a mixture of molecular sieve material and aluminum oxide. In operation, the cooling agent flows in axial direction through the filter dryer cartridge.

EP 1 028 299 A2 discloses a filter dryer for stationary cooling systems with two substantially identical filter dryer cartridges. Each of these filter dryer cartridges comprises a hollow cylindrical cartridge housing which is delimited by an inner and an outer cylinder wall as well as a lower and an upper annular end face. One of these end faces is designed as a removable cover. A loose fill of filter drying agent is housed in the interior of the cartridge housing. The cartridge housings comprise penetrations in the cylinder walls in such a way that the fills that are contained in the filter dryer cartridges can be flowed through substantially in radial direction.

### SUMMARY OF THE INVENTION

It is object of the invention to provide a device of compact construction that enables removal of particulate contaminants and dissolved or free water from a fluid and which is inexpensively and easily exchangeable.

The object is solved by a filter element for filtering a liquid, in particular oil, comprising: a filter medium that surrounds a longitudinal axis of the filter element in a ring shape and that can be flowed through by the liquid in a radial direction in relation to the longitudinal axis; and a flow-through receiving chamber which, at least in sections thereof, is delimited by a wall that can be flowed through by the liquid and in which a drying agent for removal of water from the liquid is received; wherein the filter medium and the receiving chamber containing the drying agent are non-detachably connected to each other.

The object is further solved by a fluid filter with a filter element according to the invention that is arranged in a filter housing of the fluid filter such that in operation the filter medium as well as the receiving chamber with the drying agent can be flowed through by the liquid.

Preferred embodiments are disclosed in the dependent claims and the description.

According to the invention, a filter element for filtering a liquid fluid, in particular oil, is provided. The filter element comprises a filter medium. The filter medium serves for retaining particulate contaminants that are carried by the fluid flowing into the filter element. The filter medium surrounds a longitudinal axis of the filter element in a ring shape. The filter medium can be flowed through by the fluid in a radial direction in relation to the longitudinal axis. In this way, a filter medium with a large effective filter surface can be accommodated in a minimal installation space. Thus, a great filter efficiency can be achieved despite compact dimensions of the filter element. The filter medium can be flowed through from the interior to the exterior in radial direction or, preferably, from the exterior to the interior in radial direction. Upon flow from the interior to the exterior in radial direction, the filter medium can be surrounded by a cage in order to prevent inflation of the filter medium.

The filter element comprises a receiving chamber that is at least in sections thereof delimited by a wall through which the fluid can flow. The receiving chamber is arranged such that the fluid flows serially or parallel through the receiving chamber and the filter medium. The receiving chamber is embodied to be flowed through by the fluid, i.e., the receiving chamber comprises at least one fluid inlet region and at least one fluid outlet region, wherein inlet region and outlet region can be arranged directly adjacent to each other or at a distance to each other, for example, oppositely positioned. For example, the receiving chamber can be flowed through radially or axially. A drying agent for removal of water from the fluid is accommodated in the receiving chamber. The drying agent permanently retains water dissolved in the fluid in the receiving chamber. When leaving the receiving chamber, the fluid comprises at least a reduced water content. Preferably, the drying agent enables a complete drying of the fluid. Due to the drying of the fluid in the receiving chamber, disadvantageous effects of water in the fluid, for example, corrosion, increased electrical conductivity of the fluid, and/or growth of microbes in the fluid are reduced or prevented. The flow-through wall of the receiving chamber can comprise a screen and/or a fleece material, for example, a spunbond or a meltblown. The flow-through wall can be embodied with a plastic grid and/or a metal grid. Such walls can retain the drying agent, in particular also abraded particles or fragments thereof, in the receiving chamber.

The filter medium and the receiving chamber containing the drying agent are non-detachably connected to each other. In other words, the filter medium and the receiving chamber with the drying agent form an inseparable structural unit. This facilitates servicing of the filter element. The filter medium and the receiving chamber with the drying agent can be exchanged together with minimal expenditure, in particular with few manipulations. Cumbersome demounting or mounting processes are not required. An exchange of the filter element can be required when the water absorption capacity of the drying agent in the receiving chamber is exhausted, i.e., when the drying agent can absorb no additional water anymore. Likewise, an exchange may be required when the filter medium is clogged with particulate contaminants. The wall delimiting the receiving chamber can be connected directly with the filter medium in a non-detachable manner. In this way, a particularly stable filter element can be obtained. An end disk can be provided for non-detachable connection of the filter medium with the receiving chamber. The end disk can frame the filter medium and the receiving chamber at an end face. Preferably, two end disks can be provided that frame the filter medium and the receiving chamber at oppositely positioned end faces. The end disk can be glued, welded or injection molded to the filter medium and the wall of the receiving chamber. The filter medium can partially form the wall of the receiving chamber. Non-detachably connected means in particular not detachable without destruction. The receiving chamber is in particular non-slidable and/or non-rotatable in relation to the filter medium.

The receiving chamber with the drying agent is typically arranged concentrically to the filter medium. The filter medium can advantageously be a depth filtration medium. The drying agent can be accommodated in a drying agent bag that is arranged in the receiving chamber. In this way, the introduction of the drying agent into the receiving chamber can be facilitated. At the same time, the drying agent bag can retain the drying agent, in particular fragments and/or abraded particles thereof, in the receiving chamber.

The wording “removal of water from the fluid” and “drying of the fluid” are used synonymously in the context of the present invention. The fluid to be dried is typically a liquid that also in the “dry” state, i.e., free of water, is present in the liquid aggregation state.

The receiving chamber with the drying agent can be arranged radially inside the filter medium. This enables a utilization of the volume that is surrounded by the ring-shaped filter medium. Alternatively, the receiving chamber with the drying agent can be arranged radially outside of the filter medium. In this way, a larger volume of the receiving chamber can be provided. A comparatively large quantity of drying agent can be accommodated in the outwardly positioned receiving chamber. This enables a stronger drying action of the fluid and/or drying of fluids with a particularly large water proportion. In this case, the receiving chamber itself is typically embodied in a ring shape and surrounds the filter element at the exterior side. In the aforementioned filter elements, the filter element and the receiving chamber with the drying agent can be principally flowed through serially.

Preferably, the receiving chamber extends in axial direction along the longitudinal axis substantially across the same length as the filter medium. The receiving chamber is principally arranged along the longitudinal axis in overlap with the filter medium. In particular, the receiving chamber and the filter medium, viewed in axial direction of the longitudinal axis, are located at the same position (level). This enables a particularly short construction of the filter element along the longitudinal axis. Lengths that deviate by at most 20%, preferably at most 10%, from each other can be viewed as substantially of the same length. In particular, axial top and bottom sides of the filter medium and of the receiving chamber can be arranged at the same level in relation to the longitudinal axis.

Alternatively, it can be provided that the receiving chamber is arranged so as to adjoin, preferably immediately adjoin, the filter medium in axial direction along the longitudinal axis. In this way, the filter element can be designed to be particularly thin (slim) in radial direction. The receiving chamber and the filter element can be arranged and embodied for a serial flow or for a parallel flow therethrough. Preferably, an outer diameter of the receiving chamber and an outer diameter of the filter medium are substantially of the same size. A filter housing for receiving the filter element can then be designed particularly simply, in particular cylinder-shaped. Outer diameters that deviate by at most 20%, preferably by at most 10%, from each other can be viewed as substantially of the same size.

The wall of the receiving chamber that axially adjoins the filter medium can be embodied to be fluid-tight at least in sections thereof at the outer circumferential side. This enables control of the flow through the filter element. In particular, by means of a wall of the receiving chamber that is completely fluid-tight at the outer circumferential side, a serial flow through the receiving chamber and the filter medium can be provided.

The wall of the receiving chamber can be embodied to be fluid-tight at the end face at least in sections thereof. Thus, the wall, at an end face of the receiving chamber that is oriented transverse to the longitudinal axis, cannot be flowed through by the fluid at least partially. In this way, an at least partial radial flow through the receiving chamber with the drying agent can be provided. The fluid can preferably pass in a substantially straight radial flow through the filter medium as well as through the receiving chamber with the drying agent. The wall can be embodied to be fluid-tight at one or both end faces.

The drying agent can comprise an adsorber material. Advantageously, the drying agent can comprise a porous crystal structure, in particular a molecular sieve, preferably a zeolite molecular sieve. Silica gels are suitable in particular for drying fluids with high concentrations of dissolved water. Molecular sieves are advantageously used for low concentrations of dissolved water in the fluid. The adsorber material can comprise a framework silicate. The drying agent can comprise different types of zeolite molecular sieves. The drying agent can comprise natural or synthetic zeolites. Silica gel can be present in the form of alumino silicate. The drying agent can comprise bentonite/clay minerals, for example, containing aluminum oxide, calcium sulfate, calcium carbonate; the aforementioned drying agents can be regenerated. Also, the drying agent can comprise bentonite/clay minerals that cannot be regenerated, for example, containing calcium, calcium hydride, calcium oxide, calcium sulfate, potassium hydroxide, copper sulfate, lithium aluminum hydride and/or sodium hydroxide.

The molecular sieves have typically a mesh width (pore size) of 3 to 4 angstrom so that water molecules can be absorbed. The silica gels can have an average pore size of 25 nm or 65 nm.

The drying agent, in particular in the form of zeolite molecular sieves, can be present as a powder, for example, with an average particle size of 5 μm to 10 μm (pure form of zeolite). Alternatively or additionally, the drying agent, in particular in the form of zeolite molecular sieves, can be present in bead shape (e.g., 0.1 mm to 50 mm in diameter), in rod shape, as hollow fiber membrane, as mixture of polymer and drying agent, as moldings, as solid body and/or as shaped body (in particular of composite material), preferably with a sponge or honeycomb structure.

The filter medium can be folded in a star shape. In this way, a particularly large effective filter surface can be provided. The fold size (measured in radial direction) of a folded filter medium can lie between 5 mm and 300 mm. Alternatively, the filter medium can be of a wound embodiment. This simplifies the manufacture. In particular, a wound filter medium can be embodied as a fleece material, for example, a meltblown or spunbond.

The present invention also encompasses a fluid filter with an afore described filter element according to the invention that is arranged in a filter housing of the fluid filter. In this way, the advantages of the filter element for the filtration and drying of a fluid can be utilized. A filter pot and a cover of the filter housing can be connected to each other in a detachable or non-detachable manner.

The filter housing must not be mandatorily filled completely with fluid. In this way, a volume compensation in case of a temperature increase can be realized. In this context, a pressure compensation valve is preferably provided in the housing. Alternatively or additionally, an aeration and/or venting valve can be provided.

The fluid filter can comprise a bypass valve that enables a fluid flow past the filter medium and/or past the receiving chamber with the drying agent when a permissible pressure difference between a raw side and a clean side of the fluid filter is surpassed. In this way, it can be ensured that a device with the fluid filter is supplied with (a sufficient quantity of) fluid when flow through the fluid filter is restricted or canceled. This can be the case when the viscosity of the fluid at low temperatures increases and/or when the filter medium is clogged and/or when the water absorption capacity of the drying agent is exhausted.

A filter pot of the filter housing and a cover of the filter housing can be connected to each other in a non-detachable manner. The fluid filter forms then a unit that is to be exchanged as a whole. This simplifies servicing, i.e., the exchange of the filter element. Preferably, at least one inlet opening and at least one outlet opening for the fluid are formed in the cover. This can simplify connecting the fluid filter to a device which is to be supplied with filtered and dried fluid.

An inlet opening and an outlet opening for the fluid can be embodied at oppositely positioned end faces of the filter housing. The fluid filter can then advantageously be integrated into a conduit, for example, a hose conduit, for the fluid. In particular, the fluid filter can be retrofitted into a conduit of an existing device.

The filter housing can comprise a housing cover which can be fastened to a filter head with a fluid inlet and a fluid outlet. The housing cover is typically embodied in a cup shape. The housing cover comprises principally no openings in its wall that can be flowed through in operation of the fluid filter. The housing cover can comprise a drainage opening in its wall that is closed in operation. The drainage opening can be opened prior to exchange of the filter element for draining the fluid from the fluid filter. In the mounted state, the housing cover contacts seal-tightly the filter head. For exchange of the filter element, the housing cover can be removed from the filter head. The housing cover can have a thread section in order to screw it to the filter head.

In the filter housing, an elastic element, for example, a spring, can be arranged such that the drying agent during operation is arranged substantially immobile in the receiving chamber. For example, the elastic element is arranged between housing cover and drying agent or between drying agent and filter pot bottom. Due to the elastic element, abrasion of the drying agent is avoided, in particular in case that the drying agent is present in the form of beads because a relative movement of the beads is prevented or at least reduced.

A filter element according to the invention or a fluid filter according to the invention can be installed in a device for receiving the fluid. Typically, the device contains the fluid. The device can comprise an internal combustion engine, a transmission, and/or a braking system. The device can comprise, for example, a fuel cell, a transformer, and/or a rechargeable battery. In these devices, drying of the fluid in the device is particularly important. The aforementioned devices can be configured, for example, as a part of a motor vehicle or so as to be mobile in other ways. The device can comprise a locomotive or a rail car. The device can comprise a buffer battery which, for example, serves as an intermediate storage for regeneratively generated electrical energy and its supply into a power network.

The fluid filter can be installed, for example, in an oil circuit and thereby retain dirt particles from the oil by means of the filter medium and absorb water, in particular condensed water, from the oil by means of the drying agent.

The fluid filter can be part of a thermal management module. The module comprises: a container, in particular compensation container, for receiving the liquid, the fluid filter with drying agent, a pump, at least one sensor for determining at least one process parameter, for example, temperature and/or moisture and/or pressure, and a cooler. The module can be coupled to various consumers, for example, a transmission, a battery, a rechargeable battery, transformer, electric motor, an internal combustion engine, a braking system or power electronics.

The fluid that is to be filtered and to be dried by the filter element or fluid filter is typically an oil. In particular, the oil can be a cooling oil, lubricant oil and/or a liquid on the basis of glycol. The fluid can have electrically insulating properties. The fluid can be in particular an insulating oil. The fluid can act at the same time as an insulating oil and a cooling oil. The fluid furthermore can be a cooling agent, for example, contain halogenated or non-halogenated hydrocarbons, in particular hydrofluorocarbon, or hydrofluoroether.

### BRIEF DESCRIPTION OF THE DRAWINGS

Further features and advantages of the invention result from the following detailed description of embodiments of the invention, from the claims as well as based on the Figures of the drawing showing details according to the invention. The aforementioned and still to be described features can be realized individually on their own or several combined in any combinations in variants of the invention. The features disclosed in the drawing are illustrated such that the particularities according to the invention can be made clearly visible.

FIG. 1 shows a fluid filter comprising a filter element with a ring-shaped filter medium and a radially inwardly positioned receiving chamber for drying agent as well as a filter housing with a non-detachably connected filter pot and cover, in a schematic longitudinal section.

FIG. 2 shows a fluid filter comprising a filter element with a ring-shaped filter medium and a radially outwardly positioned receiving chamber for drying agent as well as a filter housing with a non-detachably connected filter pot and cover, in a schematic longitudinal section.

FIG. 3 shows a fluid filter comprising a filter element with a ring-shaped filter medium and a receiving chamber for drying agent arranged axially below the filter element as well as a filter housing with a non-detachably connected filter pot and cover to which an adapter plate is connected, in a schematic longitudinal section.

FIG. 4 shows a fluid filter comprising a filter element with a ring-shaped filter medium and a receiving chamber for drying agent arranged axially above the filter element as well as a filter housing with a non-detachably connected filter pot and cover to which an adapter plate is connected, in a schematic longitudinal section.

FIG. 5 shows a fluid filter comprising a filter element with a ring-shaped filter medium and a radially inwardly positioned receiving chamber for drying agent as well as a filter housing with a housing cover for fastening to a filter head, in a schematic longitudinal section.

FIG. 6 shows a fluid filter comprising a filter element with a ring-shaped filter medium and a radially outwardly positioned receiving chamber for drying agent as well as a filter housing with inlet and outlet openings positioned opposite each other at the end faces, in a schematic longitudinal section.

### DESCRIPTION OF PREFERRED EMBODIMENTS

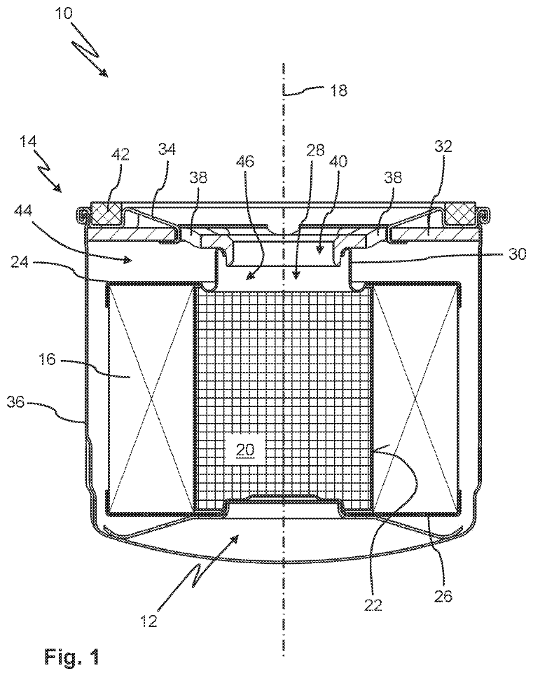

FIG. 1 shows a fluid filter 10. The fluid filter 10 comprises a filter element 12 and a filter housing 14. The filter element 12 is arranged in the filter housing 14.

The filter element 12 comprises a filter medium 16. The filter medium 16 surrounds a longitudinal axis 18 of the filter element 12 in a ring shape. The filter medium 16 is embodied folded in a star shape. The filter medium 16 can be flowed through in radial direction in relation to the longitudinal axis 18 from the exterior to the interior by a fluid.

The filter element 12 comprises a receiving chamber 20. A drying agent, not illustrated in detail, is arranged in the receiving chamber 20. The drying agent here is a silica gel. The receiving chamber 20 is arranged radially inside the ring-shaped filter medium 16. The receiving chamber 20 and the filter medium 16 extend along the longitudinal axis 18 across substantially the same length. In particular, the receiving chamber 20 and the filter medium 16 end at the end faces at approximately the same levels in relation to the longitudinal axis 18.

A wall 22 of the receiving chamber 20 can be flowed through in sections thereof by the fluid. The wall 22 is embodied here with a plastic grid. Here, a radially outwardly positioned section of the wall 22 facing the filter medium 16 can be flowed through. Furthermore, an end face section of the wall 22 arranged at the top in FIG. 1 can be flowed through.

At the end faces, the filter medium 16 is framed by a top end disk 24 and a bottom end disk 26. The bottom end disk 26 is embodied continuously closed. A radially inner partial region of the bottom end disk 26 forms of fluid-tight section of the wall 22 of the receiving chamber 20. The fluid cannot pass along the longitudinal axis 18 through the bottom end disk 26.

By means of the end disks 24, 26, the filter medium 16 and the receiving chamber 20 containing the drying agent are non-detachably connected to each other. The end disks 24, 26 can be glued or injection molded to the filter medium 16 and the wall 22 of the receiving chamber 20.

The top end disk 24 comprises a central opening 28. The central opening 28 is arranged above the flow-through end face section of the wall 22 of the receiving chamber 20. The opening 28 is surrounded by a collar 30. The collar 30 is supported seal-tightly at a cover 32 of the filter housing 14. In a further embodiment, a bypass valve, not illustrated here, can be arranged in the region of the collar 30.

The cover 32 is non-detachably connected by a seal support ring 34 of the filter housing 14 to a filter pot 36 of the filter housing 14. The seal support ring 34 is connected by crimping to the filter pot 36. The seal support ring 34 engages inlet openings 38 in the cover 32. The cover 32 comprises an outlet opening 40. The outlet opening 40 of the cover 32 is arranged axially above the central opening 28 of the top end disk 24. A sealing element 42 is arranged at the seal support ring 34. The fluid filter 10 illustrated here can be referred to as a spin-on filter or an exchangeable filter cartridge.

In operation, the fluid filter 10 is fastened to a device (not illustrated). The outlet opening 40 can comprise a thread for this purpose. The sealing element 42 contacts seal-tightly the device in the mounted state of the fluid filter 10. Fluid flows through the inlet openings 38 to a radially outwardly positioned raw side 44 of the fluid filter 10 or of the filter element 12. From there, the fluid flows radially inwardly through the filter medium 16. Particulate contaminants of the fluid are retained thereby. In this way, the filtered fluid reaches the receiving chamber 20 with the drying agent. The drying agent binds the water dissolved in the fluid and retains it in the receiving chamber 20. The fluid that is dried and filtered in this way flows through the central opening 28 and the outlet opening 40 to the device. The region inside the collar 30 below the outlet opening 40 can be referred to as a clean side 46 of the fluid filter 10 or of the filter element 12.

In an embodiment, not illustrated in detail, a spacing could be provided between the radially outer flow-through section of the wall 22 and the filter medium 16. Due to this spacing, a pressure compensation can be enabled. The volume region which is provided by the spacing between the receiving chamber 20 and the filter medium 16 could be opened by a bypass, for example, in the region of the top end disk 24, toward the clean side 46 or could be openable by means of a valve.

The filter housing 14 must not be completely filled. In this way, it can serve as a compensation container for temperature-caused volume fluctuations of the oil. In this context, a compensation valve (not illustrated) and/or a constructive connection between oil level and suction could be realized (not illustrated). This applies also to the further embodiments disclosed herein.

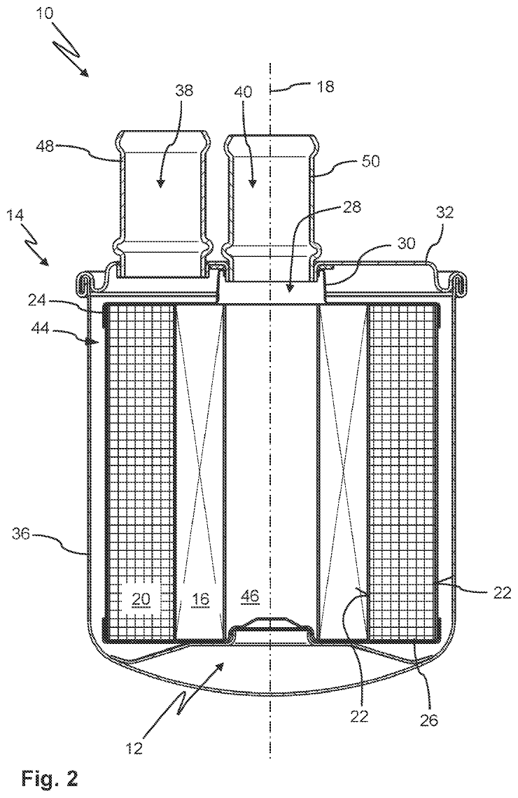

FIG. 2 shows a further fluid filter 10. The fluid filter 10 comprises a filter element 12 and a filter housing 14. The filter element 12 is arranged in the filter housing 14. The filter element 12 comprises a filter medium 16. The filter medium 16 surrounds a longitudinal axis 18 of the filter element 12 in a ring shape. The filter medium 16 is embodied here folded in a star shape. The filter medium 16 can be flowed through radially in relation to the longitudinal axis 18 from the exterior to the interior by a fluid.

The filter element 12 comprises a receiving chamber 20. In the receiving chamber 20, a drying agent is arranged, not illustrated here in detail. The drying agent is here a zeolite molecular sieve. The receiving chamber 20 is arranged radially outside of the ring-shaped filter medium 16. The receiving chamber 20 is embodied in a ring shape. The receiving chamber 20 and the filter medium 16 extend along the longitudinal axis 18 across substantially the same length. In particular, the receiving chamber 20 and the filter medium 16 end at the end faces at the same levels in relation to the longitudinal axis 18.

A wall 22 of the receiving chamber 20 can be flowed through by the fluid in sections thereof. The wall 22 is embodied here with a metal grid, namely a wire grid. Here, a radially inner section of the wall 22 that is facing the filter medium 16 can be flowed through. Moreover, a radially outer section of the wall 22 can be flowed through from a raw side 44 of the fluid filter 10 or of the filter element 12.

The filter medium 16 and the receiving chamber 20 are framed at the end faces by a top end disk 24 and a bottom end disk 26. The bottom end disk 26 is embodied continuously closed. A radially outer partial region of the bottom end disk 26 forms a fluid-tight section of the wall 22 of the receiving chamber 20. The fluid cannot pass along the longitudinal axis 18 through the bottom end disk 26. By means of the end disks 24, 26, the filter medium 16 and the receiving chamber 20 containing the drying agent are non-detachably connected to each other. The end disks 24, 26 can be glued or injection molded to the filter medium 16 and the wall 22 of the receiving chamber 20.

The top end disk 24 comprises a central opening 28. The central opening 28 is arranged above a radially inwardly positioned clean side 46 of the fluid filter 10 or of the filter element 12. The opening 28 is surrounded by a collar 30. The collar 30 is supported seal-tightly at a cover 32 of the filter housing 14. In a further embodiment, a bypass valve, not illustrated here, can be arranged in the region of the collar 30.

The cover 32 is non-detachably connected by crimping to the filter pot 36 of the filter housing 14. The cover comprises an inlet socket 48 with an inlet opening 38. Moreover, the cover 32 comprises an outlet socket 50 with an outlet opening 40. The outlet opening 40 of the cover 32 can be arranged axially above the central opening 28 of the top end disk 24.

Fluid conduits for supplying the fluid to the fluid filter 10 or for discharging the fluid from the fluid filter 10 can be connected to the inlet and outlet sockets 48, 50 (not illustrated). In operation, the fluid flows through the inlet opening 38 into the radially outwardly positioned raw side 44. From here, the fluid flows through the radially outer flow-through section of the wall 22 radially inwardly into the receiving chamber 20 with the drying agent. The drying agent absorbs the water dissolved in the fluid and retains it in the receiving chamber 20. The dried fluid flows through the radially inner flow-through section of the wall 22 to the filter medium 16 and further radially inwardly through the latter to the clean side 46. Particulate contaminants of the fluid are retained thereby. The fluid that has been dried and filtered in this way flows through the central opening 28 and the outlet opening 40 out of the fluid filter 10.

In an embodiment, not illustrated in detail, a spacing could be provided between the radially inner flow-through section of the wall 22 and the filter medium 16. Due to this spacing, a pressure compensation can be enabled. The volume region which is provided by the spacing between the receiving chamber 20 and the filter medium 16 could be opened by a bypass, for example, in the region of the top end disk 24, toward the clean side or could be openable by means of a valve.

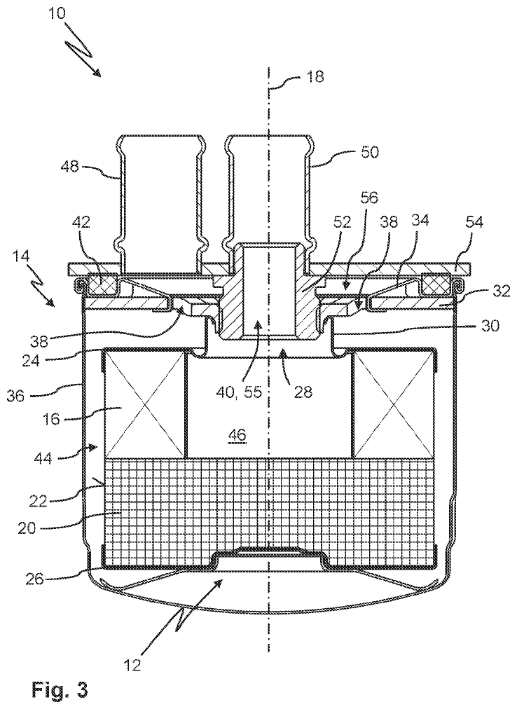

FIG. 3 shows a further embodiment of a fluid filter 10. The fluid filter 10 comprises a filter element 12 and a filter housing 14. The filter element 12 is arranged in the filter housing 14.

The filter element 12 comprises a filter medium 16. The filter medium 16 surrounds a longitudinal axis 18 of the filter element 12 in a ring shape. The filter medium 16 is embodied here folded in a star shape. The filter medium 16 can be flowed through radially in relation to the longitudinal axis 18 from the exterior to the interior by a fluid.

The filter element 12 comprises a receiving chamber 20. A drying agent, not illustrated in detail here, can be arranged in the receiving chamber 20. The drying agent here is a zeolite molecular sieve. The receiving chamber 20 is arranged in axial direction along the longitudinal axis 18 below the ring-shaped filter medium 16. Here, the receiving chamber 20 adjoins in the axial direction immediately the filter medium 16. The receiving chamber 20 and the filter medium 16 can comprise outer diameters of the same size. The receiving chamber 20 is embodied continuously in radial direction. In other words, the volume of the receiving chamber 20 corresponds approximately to a solid cylinder.

A wall 22 of the receiving chamber 20 can be flowed through by the fluid in sections thereof. The wall 22 here is formed by a screen fabric. Here, a radially outer section of the wall 22 facing a raw side 44 of the fluid filter 10 or of the filter element 12 can be flowed through. Moreover, an axially upper section of the wall 22 can be flowed through toward a clean side 46 of the fluid filter 10 or of the filter element 12. The screen fabric enveloping the receiving chamber 20 is fixedly connected here to the filter medium 16, in particular glued thereto. The receiving chamber 20 and the filter medium 16 are connected in this way to an inseparable unit.

The filter medium 16 and the receiving chamber 20 are framed at the end faces by a top end disk 24 and a bottom end disk 26. The bottom end disk 26 is embodied continuously closed. The bottom end disk 26 forms of fluid-tight section of the wall 22 of the receiving chamber 20. The fluid cannot pass along the longitudinal axis 18 through the bottom end disk 26. The end disks 24, 26 can be glued or injection molded to the filter medium 16 and the wall 22 of the receiving chamber 20, respectively.

The top end disk 24 comprises a central opening 28. The central opening 28 is arranged above the radially inwardly positioned clean side 46 of the fluid filter 10 or of the filter element 12. The opening 28 is surrounded by a collar 30. The collar 30 is supported seal-tightly at a cover 32 of the filter housing 14. In a further embodiment, a bypass valve, not illustrated here, can be arranged in the region of the collar 30.

The cover 32 is non-detachably connected by a seal support ring 34 of the filter housing 14 to the filter pot 36 of the filter housing 14. The seal support ring 34 is connected by crimping to the filter pot 36. The seal support ring 34 engages inlet openings 38 in the cover 32. The cover 32 comprises an outlet opening 40. The outlet opening 40 of the cover 32 is arranged axially above the central opening 28 of the top end disk 24. A sealing element 42 is arranged at the seal support ring 34.

A connector plate 54 is attached to the cover 32 by means of an adapter piece 52. The adapter piece 52 is screwed into the outlet opening 40 of the cover 32. At the top side, the adapter piece 52 passes through the connector plate 54 with formation of a fluid-tight connection. An outlet socket 50 adjoins the adapter piece 52 in upward direction. The outlet socket 50 engages fluid-tightly between the adapter piece 52 and the connector plate 54. The adapter piece 52 comprises a through passage 55 connecting in fluid communication the central opening 28 or a clean side 46 arranged underneath to the outlet socket 50.

An inlet socket 48 is furthermore introduced into the connector plate 54 with formation of a fluid-tight connection. The inlet socket 48 opens into an annular chamber 56 above the cover 32. The sealing element 42 seals the annular chamber 56 radially outwardly.

Fluid conduits for supplying the fluid to the fluid filter 10 or for discharging the fluid from the fluid filter 10 can be connected to the inlet and outlet sockets 48, 50 (not illustrated). In operation, the fluid flows through the inlet socket 48 into the annular chamber 56 and from there through the inlet openings 38 to the radially outwardly positioned raw side 44.

The filter medium 16 and the receiving chamber 20 with the drying agent are connected here in parallel fluid communication. The fluid flows from the raw side 44 partially through the filter element 16 and partially through the receiving chamber 20 containing the drying agent to the radially inner clean side 46 positioned above the receiving chamber 20. The drying agent absorbs in this context water dissolved in the fluid and retains it in the receiving chamber 20. The filter medium 16 retains particulate contaminants of the fluid. The partial flows of the fluid that have been partially dried and partially filtered in this way mix in the clean side 46 so that fluid with minimal moisture and reduced particle contents compared to the raw side 44 is generated. From the clean side 46, the fluid flows through the central opening 28, the through passage 55 in the adapter piece 52, and the outlet socket out of the fluid filter 10.

In a further embodiment, not illustrated in detail, the radially outer section of the wall 22 of the receiving chamber 22 could be embodied fluid-tightly. The fluid would then have to flow from the raw side 44 through the filter medium 16 to the clean side 46. Here, the fluid could pass through the upper flow-through section of the wall 22 into the receiving chamber 20 and the entrained water could be removed there. The fluid filtered and dried in this way would pass again to the clean side 46 through the upper flow-through section of the wall 22. From the clean side 46, the fluid, as described above, could flow out of the fluid filter 10.

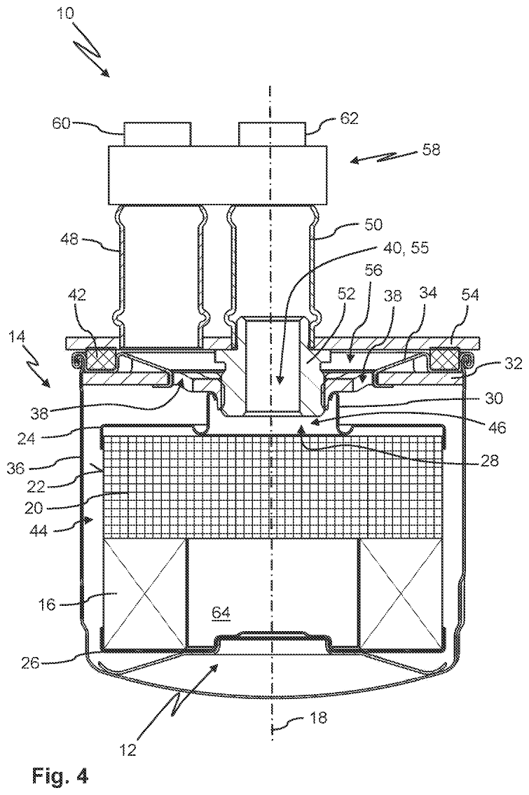

FIG. 4 shows a fourth embodiment of a fluid filter 10. The fluid filter 10 comprises a filter element 12 and a filter housing 14. The filter element 12 is arranged in the filter housing 14.

The filter element 12 comprises a filter medium 16. The filter medium 16 surrounds a longitudinal axis 18 of the filter element 12 in a ring shape. The filter medium 16 is embodied here folded in a star shape. The filter medium 16 can be flowed through in radial direction in relation to the longitudinal axis 18 from the exterior to the interior by a fluid.

The filter element 12 comprises a receiving chamber 20. A drying agent, not illustrated in detail, is arranged in the receiving chamber 20. The drying agent is here a zeolite molecular sieve. The receiving chamber 20 is arranged in axial direction along the longitudinal axis 18 above the ring-shaped filter medium 16. Here, the receiving chamber 20 adjoins in axial direction immediately the filter medium 16. The receiving chamber 20 and the filter medium 16 comprise outer diameters of the same size. The receiving chamber 20 is embodied continuously in radial direction. In other words, the volume of the receiving chamber 20 corresponds to a solid cylinder.

A wall 22 of the receiving chamber 20 can be flowed through in sections thereof by the fluid. The wall 22 is formed here with a screen fabric. A radially outer section of the wall 22 facing a raw side 44 of the fluid filter 10 or of the filter element 12 can be flowed through. Moreover, an axially lower section of the wall 22 can be flowed through. Moreover, an axially upper, radially inwardly positioned section of the wall 22 can be flowed through. The screen fabric enveloping the receiving chamber 20 is glued here to the filter medium 16. The receiving chamber 20 and the filter medium 16 are connected in this manner to an inseparable unit.

The filter medium 16 and the receiving chamber 20 are framed at the end faces by a top end disk 24 and a bottom end disk 26. The bottom end disk 26 is embodied continuously closed.

The bottom end disk 26 closes the filter medium 16 in downward direction fluid-tightly. The fluid cannot pass along the longitudinal axis 18 through the bottom end disk 26. The end disks 24, 26 can be glued or injection molded to the filter medium 16 and the wall 22 of the receiving chamber 20, respectively.

The top end disk 24 comprises a central opening 28. The central opening 28 is arranged above a radially inwardly positioned clean side 46 of the fluid filter 10 or of the filter element 12. The opening 28 is surrounded by a collar 30. The collar 30 is supported seal-tightly at a cover 32 of the filter housing 14.

The cover 32 is non-detachably connected by a seal support ring 34 of the filter housing 14 to a filter pot 36 of the filter housing 14. The seal support ring 34 is connected by crimping to the filter pot 36. The seal support ring 34 engages inlet openings 38 in the cover 32. The cover 32 comprises an outlet opening 40. The outlet opening 40 of the cover 32 is arranged axially above the central opening 28 of the top end disk 24. A sealing element 42 is arranged at the seal support ring 34.

A connector plate 54 is attached to the cover 32 by means of an adapter piece 52. The adapter piece 52 is screwed into the outlet opening 40 of the cover 32. At the top side, the adapter piece 52 passes through the connector plate 54 with formation of a fluid-tight connection. An outlet socket 50 adjoins in upward direction the adapter piece 52. The outlet socket 50 engages fluid-tightly between the adapter piece 52 and the connector plate 54. The adapter piece 52 comprises a through passage 55 which connects in fluid communication the central opening 28 or a clean side 46 positioned underneath to the outlet socket 50.

Furthermore, an inlet socket 48 is introduced with formation of a fluid-tight connection in the connector plate. The inlet socket 48 opens into an annular chamber 56 above the cover 32. The sealing element 42 seals the annular chamber 56 radially outwardly.

A bypass valve 58 is placed here onto the inlet and outlet sockets 48, 50. The bypass valve 58 comprises an inlet 60 and an outlet 62. Fluid conduits for supplying the fluid to the fluid filter 10 or for discharging the fluid from the fluid filter 10 can be connected to the inlet 60 and the outlet 62 (not illustrated).

In regular operation (normal operation), the fluid flows through the inlet 60 and the inlet socket 48 into the annular chamber 56 and from there through the inlet openings 38 into the radially outwardly positioned raw side 44. Filtered and dried fluid flows in regular operation from the clean side 46 through the through passage 55 in the adapter piece, the outlet socket 50, and the outlet 62 out of the fluid filter 10.

When a permissible pressure difference between the raw side 44 and the clean side 46 is surpassed, a flow path opens in the bypass valve 58 which directly extends from the inlet 60 to the outlet 62. In this manner, the fluid is guided past the filter element 12, i.e., past the filter medium 16 as well as past the receiving chamber 20 with the drying agent.

The filter medium 16 and the receiving chamber 20 with the drying agent are here connected in fluid communication parallel to each other. The fluid flows in normal operation from the raw side 44 partially through the filter medium 16 into an interior 64. Partially, the fluid flows through the receiving chamber 20 containing the drying agent to the clean side 46 which is here positioned in the region radially inside the collar 30. From the interior 64, the fluid flows in axial direction through the receiving chamber 20 to the clean side 46.

The drying agent absorbs in this context water dissolved in the fluid and retains it in the receiving chamber 20. The filter medium 16 retains particulate contaminants of the fluid. The partial flows of the fluid that are partially dried and partially filtered and dried in this way mix at the clean side 46 so that a fluid with reduced moisture and reduced particle contents compared to the raw side 44 is generated. From the clean side 46, the fluid flows through the through passage 55 in the adapter piece 52 and the outlet socket 50 as well as the outlet 62 of the bypass valve 58 out of the fluid filter 10.

In a further embodiment, not illustrated in detail, the radially outer section of the wall 22 of the receiving chamber 20 could be embodied fluid-tightly. The fluid then would have to flow from the raw side 44 through the filter medium 16 into the interior 64. From there, the fluid could flow upwardly into the receiving chamber 20 and the entrained water could be removed there. The fluid filtered and dried in this way would then pass through the upper flow-through section of the wall 22 to the clean side 46. From the clean side, the fluid could flow out of the fluid filter 10, as described above. In this way, a serial flow through the filter medium 16 and the receiving chamber 20 with the drying agent could be provided.

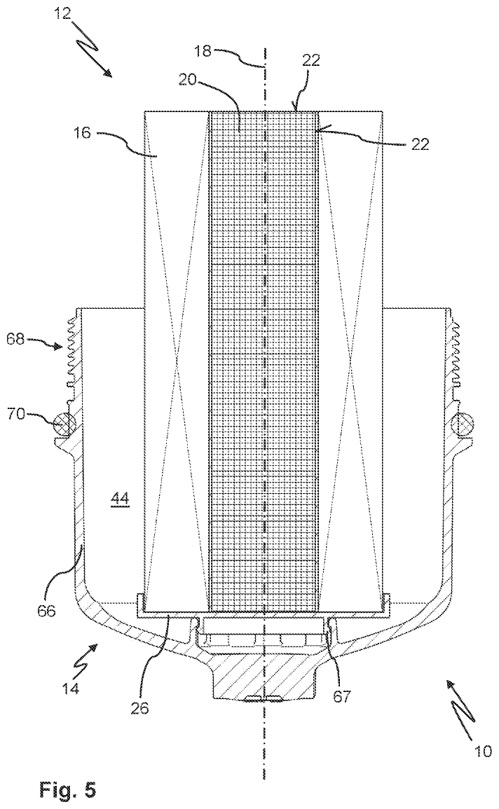

FIG. 5 shows a fluid filter 10 in a fifth embodiment. The fluid filter 10 comprises a filter element 12 and a filter housing 14. The filter element 12 is arranged in the filter housing 14.

The filter element 12 comprises a filter medium 16. The filter medium 16 surrounds a longitudinal axis 18 of the filter element 12 in a ring shape. The filter medium 16 is embodied folded in a star shape here. The filter medium 16 can be flowed through radially in relation to the longitudinal axis 18 from the exterior to the interior by a fluid.

The filter element 12 comprises a receiving chamber 20. The drying agent, not illustrated in detail, is arranged in the receiving chamber 20. The drying agent is here a silica gel. The receiving chamber 20 is arranged radially inside of the ring-shaped filter medium 16. The receiving chamber 20 and the filter medium 16 extend along the longitudinal axis 18 across the same length. In particular, the receiving chamber 20 and the filter medium 16 end at the end faces at the same levels in relation to the longitudinal axis 18.

A wall 22 of the receiving chamber 20 can be flowed through in sections thereof by the fluid. The wall 22 is embodied here with a plastic grid. A radially outer section of the wall 22 facing the filter medium 16 can be flowed through. Furthermore, an end face section of the wall 22 arranged at the top in FIG. 5 can be flowed through.

The filter medium 16 and the receiving chamber 20 are framed at an end face by a bottom end disk 26. The bottom end disk 26 is embodied continuously closed. A radially inner partial region of the bottom end disk 26 forms of fluid-tight section of the wall 22 of the receiving chamber 20. The fluid cannot pass along the longitudinal axis 18 through the bottom end disk 26. By means of the end disk 26, the filter medium 16 and the receiving chamber 20 containing the drying agent are non-detachably connected to each other. The end disk 26 can be glued or injection molded to the filter medium 16 and the wall 22 of the receiving chamber 20.

The filter housing 14 comprises here a housing cover 66. The housing cover 66 is embodied pot-shaped (cup-shaped). The filter element 12 is locked by locking noses 67 of the bottom end disk 26 to the housing cover 66.

The housing cover 66 is connectable to a filter head (not illustrated) with a fluid inlet and a fluid outlet. For this purpose, the housing cover 66 comprises a thread section 68. For sealing the housing cover 66 against the filter head, an annular sealing element 70, here an O-ring, is provided. The annular sealing element 70, viewed from an open side of the pot-shaped housing cover 66, is held behind or beyond the thread section 68 at the housing cover 66. The filter head can serve as a compensation container.

In regard to its function and flow therethrough in the mounted state of the fluid filter 10 at the filter head, the filter element 12 of FIG. 5 corresponds substantially to the filter element 12 of FIG. 1. Reference is being had to the above explanations in this context.

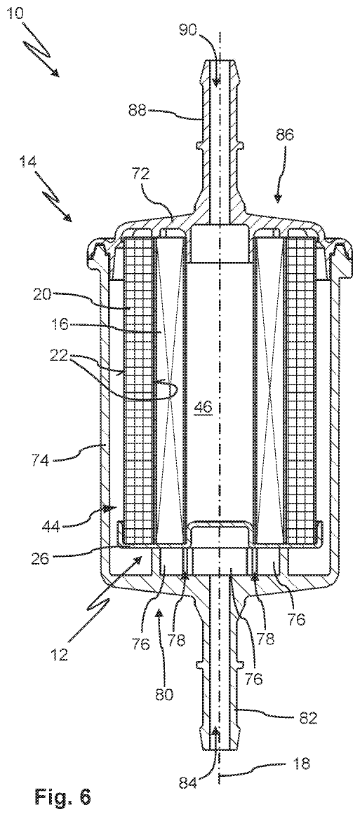

FIG. 6 shows a fluid filter 10 in a sixth embodiment. The fluid filter 10 comprises a filter element 12 and a filter housing 14. The filter element 12 is arranged in the filter housing 14.

The filter element 12 comprises a filter medium 16. The filter medium 16 surrounds a longitudinal axis 18 of the filter element 12 in a ring shape. The filter medium 16 is embodied here in a wound configuration. The filter medium 16 can be flowed through radially in relation to the longitudinal axis 18 from the exterior to the interior by a fluid.

The filter element 12 comprises a receiving chamber 20. A drying agent, not illustrated in detail, is arranged in the receiving chamber 20. The drying agent is here a zeolite molecular sieve. The receiving chamber 20 is arranged radially outside of the ring-shaped filter medium 16. The receiving chamber 20 and the filter medium 16 extend along the longitudinal axis 18 about the same length. In particular, the receiving chamber 20 and the filter medium 16 end at the end faces at the same levels in relation to the longitudinal axis 18.

A wall 22 of the receiving chamber 20 can be flowed through in sections thereof by the fluid. The wall 22 is embodied here by a metal grid, namely a wire grid. Here, a radially inner section of the wall 22 facing the filter medium 16 can be flowed through. Moreover, a radially outer section of the wall 22 can be flowed through from a raw side 44 of the fluid filter 10 or of the filter element 12.

The filter medium 16 and the receiving chamber 20 are framed at an end face by a bottom end disk 26. The bottom end disk 26 is embodied continuously closed. A radially outer partial section of the bottom end disk 26 forms a fluid-tight section of the wall 22 of the receiving chamber 20. The fluid cannot pass along the longitudinal axis 18 through the bottom end disk 26. By means of the end disk 26, the filter medium 16 and the receiving chamber 20 containing the drying agent are non-detachably connected to each other. The end disks 26 can be glued or injection molded to the filter medium 16 and the wall 22 of the receiving chamber 20.

At the top side, the filter medium 16 end the wire grid surrounding the receiving chamber 20 are supported at a cover part 72 of the filter housing 14. The cover part 72 is fluid-tightly placed onto a pot part 74 of the filter housing 14. The structural unit which is formed of the filter medium 16 and the receiving chamber 20 with the drying agent is held in axial direction between the cover part 72 and the pot part 74. The bottom end disk 26 is supported at axially projecting ribs 76 of the pot part 74.

Flow openings 78 are formed between the ribs 76. The pot part 74 comprises an inlet socket 82 with an inlet opening 84 at a bottom end face 80. The inlet opening 84 of the inlet socket 82 opens radially inside the ribs 76. In operation of the fluid filter 10, the fluid flows from here through the flow openings 78 into a radially outwardly positioned region of a raw side 44 of the fluid filter 10 or of the filter element 12. From here, the fluid flows, as described above in regard to FIG. 2, radially inwardly to a clean side 46. The filtered and dried fluid flows from the clean side 46 through an outlet socket 88 with an outlet opening 90, embodied at a top end face 86 at the cover part 72, out of the fluid filter 10.

According to the invention, all structural configurations of the unit of filter medium 16 and of the receiving chamber 20 containing the drying agent illustrated in FIGS. 1 to 6 can be combined with all structural configurations of the filter housing 14 illustrated in FIGS. 1 to 6. As needed, the filter housings 14 may have to be adapted appropriately for a suitable flow through the filter medium 16 and the receiving chamber 20 with the drying agent. Likewise, the units of filter element 16 and receiving chamber 20, in particular in regard to the design of the end face end regions with the end disks 24, 26, can be adapted to the various structural configurations of the filter housings 14.

What is claimed is:

1. A filter element for filtering a liquid, the filter element comprising:
a filter medium surrounding a longitudinal axis of the filter element in a ring shape and configured to be flowed through by the liquid in a radial direction in relation to the longitudinal axis;
a flow-through receiving chamber delimited, at least in sections thereof, by a wall configured to be flowed through by the liquid, wherein the receiving chamber contains a drying agent configured to remove water from the liquid;
wherein the filter medium and the receiving chamber containing the drying agent are non-detachably connected to each other.

2. The filter element according to claim 1, wherein the receiving chamber containing the drying agent is arranged radially inside the filter medium.

3. The filter element according to claim 1, wherein the receiving chamber containing the drying agent is arranged radially outside of the filter medium.

4. The filter element according to claim 1, wherein the receiving chamber containing the drying agent and the filter medium extend substantially across the same length in an axial direction along the longitudinal axis.

5. The filter element according to claim 1, wherein the receiving chamber containing the drying agent is arranged so as to adjoin the filter medium in an axial direction along the longitudinal axis.

6. The filter element according to claim 5, wherein an outer diameter of the receiving chamber containing the drying agent and an outer diameter of the filter medium are substantially of the same size.

7. The filter element according to claim 5, wherein the wall of the receiving chamber containing the drying agent comprises an outer circumferential side and the outer circumferential side is fluid-tight at least in sections thereof.

8. The filter element according to claim 1, wherein the wall of the receiving chamber containing the drying agent comprises an end face and the end face is fluid-tight at least in sections thereof.

9. The filter element according to claim 1, wherein the drying agent comprises a crystalline porous adsorber material.

10. The filter element according to claim 9, wherein the crystalline porous adsorber material is a molecular sieve.

11. The filter element according to claim 10, wherein the molecular sieve is a zeolite molecular sieve with a pore size of 3 angstrom to 4 angstrom.

12. A fluid filter comprising:
a filter housing;
a filter element comprising a filter medium surrounding a longitudinal axis of the filter element in a ring shape and configured to be flowed through by the liquid in a radial direction in relation to the longitudinal axis, and further comprising a flow-through receiving chamber delimited, at least in sections thereof, by a wall configured to be flowed through by the liquid, wherein the receiving chamber contains a drying agent configured to remove water from the liquid, wherein the filter medium and the receiving chamber containing the drying agent are non-detachably connected to each other;
wherein the filter element is arranged in the filter housing such that, in operation of the fluid filter, both the filter medium and the receiving chamber containing the drying agent are flowed through by the liquid.

13. The fluid filter according to claim 12, further comprising a bypass valve that permits a fluid flow past the filter medium and/or past the receiving chamber containing the drying agent when a permissible pressure difference between a raw side and a clean side of the fluid filter is surpassed.

14. The fluid filter according to claim 12, wherein the filter housing comprises a filter pot and a cover, wherein the filter pot and the cover are connected non-detachably to each other.

15. The fluid filter according to claim 14, wherein the cover comprises at least one inlet opening for the liquid and at least one outlet opening for the liquid.

16. The fluid filter according to claim 12, wherein the filter housing comprises a first end face and a second end face positioned opposite the first end face, wherein an inlet opening for the liquid is arranged at the first end face, and wherein an outlet opening for the liquid is arranged at the second end face.

17. The fluid filter according to claim 12, wherein the filter housing comprises a housing cover configured to be fastened to a filter head comprising a fluid inlet and a fluid outlet.

18. A thermal management module comprising a filter element according to claim 1.

19. A thermal management module comprising a fluid element according to claim 12.
